(19) United States
(12) Patent Application Publication
(10) Pub. No.: US 2002/0169659 A1
(43) Pub. Date: Nov. 14, 2002

(54) METHOD FOR INCLUDING PROMOTIONS IN A BROADCAST SCHEDULE

(76) Inventors: SRINIVAS BOLLAPRAGADA, NISKAYUNA, NY (US); HONG CHENG, NISKAYUNA, NY (US); MARY CLARKESON PHILLIPS, DELMAR, NY (US)

Correspondence Address: DAVID C GOLDMAN, GENERAL ELECTRIC COMPANY, CRD PATENT DOCKET ROOM 4A59, P O BOX 8 BUILDING K 1 SALAMONE, SCHENECTADY, NY, 12301

(21) Appl. No.: 09/215,384

(22) Filed: Dec. 18, 1998

(51) Int. Cl. G06F 17/60; H04N 7/025; H04N 7/10; H04N 5/222

(52) U.S. Cl. 705/14; 725/32

(57) ABSTRACT

A scheduling method provides for the placement of promotions within a broadcast schedule for providing maximum effect. Broadcast networks typically allow a set amount of time per hour in order to broadcast promotions for their own shows. A goal when scheduling these promotions is to reach the largest audience of the desired demographic. For example, it is advantageous to schedule promotions for dramatic shows during other dramatic shows and promotions for comedies during comedies. Other criteria may be employed in order to maximize the effect. The method described herein, calculates a reward function for every promotion against each show in the schedule, and through further analysis automatically schedules promotions during television shows to provide an optimal effect.

### FIELD OF THE INVENTION

The present invention relates generally to a method for scheduling promotions or other items to be aired in a broadcast schedule for a media outlet, and more particularly to a method for optimizing the process of scheduling so that a number of desired criteria are met.

### BACKGROUND OF THE INVENTION

National, cable, and local television networks provide a schedule of television programming for its viewing audience. Prior to the broadcasting of the television programs, much thought is put into which day and at what time a particular program will be broadcast. An entire schedule is put together with the hopes of maximizing viewership of their programs. In order to increase the viewership of television shows, networks schedule on-air promotions during the broadcast of other TV shows. The shows to be promoted are commonly known as projects. The promotions which are created to advertise the projects typically consist of a scene from the show and an announcement of the air date and air time. A certain amount of time is set aside in a television schedule for including promotions.

Every week, the promotion schedule for the following week is determined. The projects, based on their contents (genre), are promoted to different demographics and to different levels of intensity. In some cases, there are several different promotions of varying length and content available to promote a given project. The objective is to schedule promotions on shows to maximize the effectiveness of the promotion campaign for the week. In many cases, the promotions are scheduled manually. Schedulers create a chart listing all the shows and times available and the inventory for each. When inserting the promotions the schedulers know that certain promotions have to be scheduled first, some can only be scheduled in one particular time slot (for example, “stay tuned for Show A” is only useful if it appears immediately before Show A). Others have to be promoted at regular times each evening. These types of promotions have to be entered before the others. In the past, the schedulers would have to write in all the projects to be promoted and keep track of how many impressions were made for each project. They would pencil in the promotions, trying to juggle all the factors to create an optimum schedule. This involved meeting the number of exposures desired in a way that takes into consideration a number of factors, while staying within the inventory limitations.

### SUMMARY OF THE INVENTION

The inventors have recognized that objective criteria may be used in order to evaluate the effectiveness of broadcasting promotions at strategic points during the television schedule. Through employing these objective criteria, an automated process may be created which simplifies the scheduling of the promotions.

Described herein is an automated process for placing promotion or other items in a broadcast schedule for a media outlet. Radio and television stations periodically include promotions for shows to be broadcast at a later date during the broadcast of other shows in the schedule. The effectiveness of scheduling a promotion at a particular date or time may be measured using objective standards. The demographic group to which the promotion is broadcast, the length of time between when the promotion is broadcast and the project is broadcast, the genre of the show on which the promotion is broadcast, the length of the promotion, and whether the promotion is broadcast consecutively with promotions for other projects are some of the factors which may be quantized. Other factors which may be considered in scheduling a promotion are whether there is sufficient inventory on shows being broadcast to include the promotion, and whether an impression requirement for a promotion has been met.

Using a number of the above factors, a unique reward function may be calculated for the placement of a promotion during a particular show. Using this calculated reward, additional analysis may be performed which may include whether the desired number of impressions have been met for a particular project and what is the penalty for not achieving this. Taking into account all these factors, a computation may be performed to maximize the effectiveness of the entire schedule.

A linear analysis may also be performed which provides less computational resources and does a show by show analysis of the effect of incorporating particular promotions on particular shows. In the first step of this process, an analysis is performed for each promotion versus every show on the schedule. A probability function is calculated for each promotion relative to a show as to whether the promotion will be broadcast. These probabilities are then listed in order from greatest to smallest. After this list is compiled, additional analysis are performed for each promotion as to whether it will appear on the identified show.

A first analysis which may be performed is whether there is sufficient inventory on the identified show in order to broadcast the promotion. For example, a promotion may be one minute long and there may only be inventory for a thirty second broadcast. If there is sufficient inventory on this show to broadcast the promotion, the second step may be to determine whether the desired impressions requirement have been met for the project. Prior to broadcasting the promotions, a particular project will have an impressions requirement which is basically the number of people the promotions for the project have to reach during the next broadcast schedule. If the impressions requirement for a particular project have been met, the next promotion with the highest probability on the list is chosen and the analysis is begun again. If the impressions requirements have not been met, a final step which may be performed is whether the promotion is being broadcast in too close a proximity to either the same promotion or another promotion for the same project, such that the audience being reached is unnecessarily duplicated.

Numerous modifications and additions will be apparent to those skilled in the art upon further consideration of the invention.

### BRIEF DESCRIPTION OF THE DRAWINGS

FIG. 1 discloses an example of a network television schedule during prime time.

FIG. 2 discloses a table which includes calculated fractional values for the assignment of promotions on television shows.

FIG. 3 discloses a flow chart which describes in detail the steps performed in the promotion scheduling process.

### DETAILED DESCRIPTION OF THE INVENTION

Television and radio networks provide a medium for broadcasting a number of messages, which includes those of the advertisers of different products. One goal of a network is to increase the listenership or viewership of its programs in order to entice advertisers to pay to have their commercials included on particular shows. One tool that networks use in order to increase viewership, are to include on air promotions for their own programs. Promotions are short advertisements for the shows and typically consist of a scene from the show and an announcement of the air date and time of the show. By creating an intriguing promotion for a show and broadcasting it to reach the proper audience, the listenership or viewership for the show may increase. A typical network may allocate a set amount of time per hour for airing promotions.

Many factors may come into play to determine the best usage of the promotion time. However, these factors all include a common consideration, which is the need to reach as many potential viewers for the promoted projects as possible. Strategies are established to maximize exposure by reaching a set number of impressions, i.e., the number of total viewers who see the promotion. Impressions, and thus exposure, may be broken down by demographic groups. If one demographic (for example, women 18-49) is judged more likely to view a particular project, then promotions are best aired on shows that already appeal to that group. Promotions can be targeted to reach those in the group, or can use the more general strategy of showing it to all demographics.

Other factors which affect the effectiveness of the promotion include the recency of the broadcast. People to tend to forget over time, so therefore the longer the gap between the airing of the promotion and the time of the show the less effective the promotion. A promotion that airs the day before the project air time, is more effective in building the audience than one that airs a week before. A long promotion may generally be more effective than a short one since it gives the viewer more time to notice the show promoted. Further, a promotion for a lineup of several shows may make a greater impression than one covering a single show.

Some further criteria may be the matching of types of shows (genres). In the context of television, comedies and dramas attract different audiences, and talk shows appeal to different groups than soap operas. A promotion is most effective if it talks about a show that is in the same genre as the show in which the promotion airs.

Although the invention described herein is applicable to any number of media broadcasters, the following description will be in the context of television programming. Television networks traditionally divide a broadcasting day into multiple segments. Prime time—currently 8:00 p.m. to 11:00 p.m. Monday through Saturday and 7:00 p.m. to 11:00 p.m. on Sunday is when most viewers are watching and where networks concentrate their efforts. Other network shows may be broadcast during the “daytime” usually thought of as a primarily game shows, soap operas, and talk shows. Other significant portions of the schedule include programs for “late night,” the news and news related shows, sports, as well as children and teenagers. “Fringe” refers to all other times when viewership is usually low. Thus, the network breaks down the schedule into various day parts such as prime time, day time, news, sports, late night, early morning and fringe day-parts. When broadcasting promotions for a show, it is usually most effective when it is broadcast in the same day-part that the project will be aired. It is also more effective to scatter promotions throughout the schedule so it is exposed to a larger number of people. Two consecutive promotions will reach a nearly identical audience, but if there is a time gap between the promotions, they will reach more people who didn't happen to see the promotion before.

Further, all projects may not hold equal importance for the network. Some miniseries, specials, and movies may have higher priorities than the regularly scheduled shows and as such, require more exposure to create as large an audience as possible. Finally, there are inventory constraints, caused by the limited amount of time available for promotions on each show. A certain time slot might be ideal for several promotions, but there may only be enough time available for one or two. The priority of a project is one way to determine which to use, with everything else being equal. But if all things are not equal, all these factors have to be considered by a program planner.

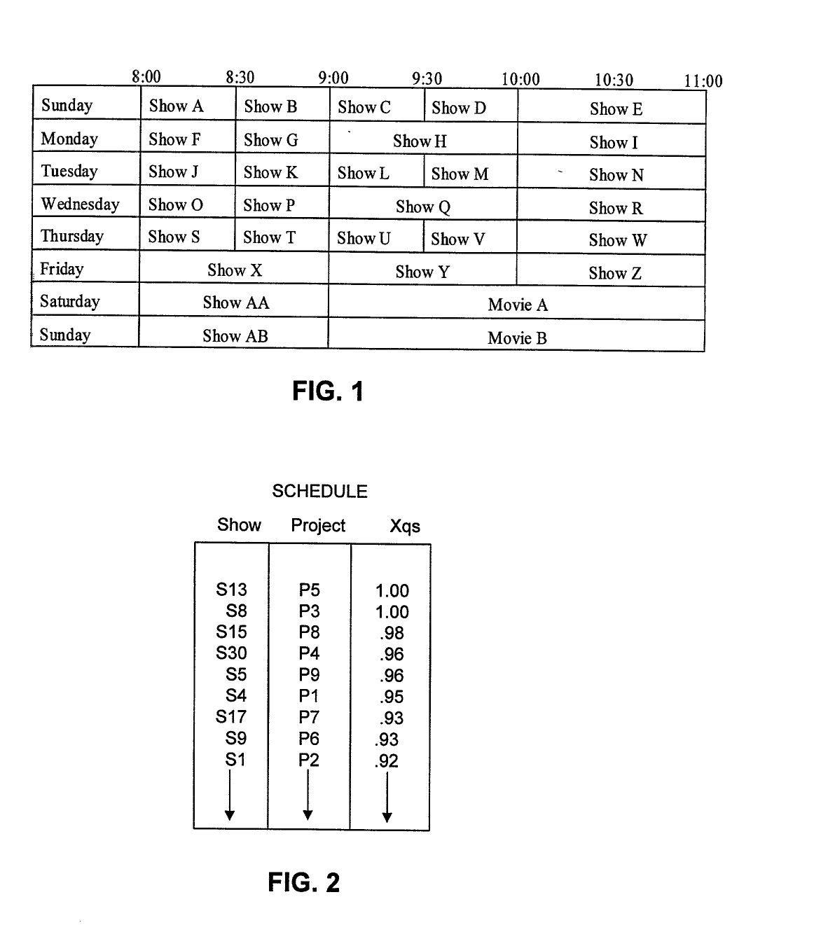

Disclosed herein is a method which automates the process of scheduling promotions in a broadcast schedule. Shown in FIG. 1 is an example of a TV schedule for a network for a week during prime time. Included in the schedule are a variety of thirty-minute shows, hour-long shows, and two-hour movies. If, for example, a limited amount of time per hour for promotions is allowed, the method described herein optimizes the inclusion of the promotions in order to give the greatest chance of increasing viewership for those particular shows.

Every week, the promotion schedule for the following week is determined. On every show in the program schedule, a fixed amount of inventory is set aside for airing promotions. A list of projects that are to be promoted are made available along with their desired demographics and the number of impressions that are required for each project. These criteria are established by network employees or consultants. A number of different promotions may be available for promoting each project. The objective is to schedule the available promotions on the following week's shows to maximize the total effectiveness of the promotion schedule while meeting the desired impressions requirements for the project.

In order to quantify the benefits of airing a promotion on a particular show, a unique reward function is calculated. The reward function, R_{qs}, provides a novel measure for the effectiveness of scheduling a promotion q on a show s. The impact of the airing of a promotion includes a combination of several factors. A real number is assigned to each factor in promotion placement. This is done heuristically based on current knowledge and experience of those at the network. These numbers are then multiplied to obtain the effectiveness of the given promotion placement. The factors include:

Show projection (Aₛₕ): Projected audience size. The larger the audience the more effective the promotion. The multiplying term in the reward function corresponding to this factor is chosen to be the number of viewers in the Homes demographic.

Recency (rₜ): The amount of time between the air time of the promotion and the air time of the project. Smaller values may be assigned as the time between the promotion and the projects air time increases.

Length of promotion (L_{q}): Number of seconds in the promotion. A sixty-second (or longer) promotion is given a higher value and shorter promotions are given a smaller value.

Show similarity (genre)(Gₜ): Promotions are most effective when the project is in the same genre (comedy, drama, etc. as the show). Its terms in the reward function take a higher value when the genres match.

Number of shows promoted (Nₜ): The more shows in the line up, the more effective is the promotion. A four show line up is assigned a higher value than one with fewer shows.

Show day part (Dₜ): Promotions are most effective if the project is broadcast in the same day part as the show. When the day parts match, this term takes a maximum value.

Duplication (Pₜ): The elapsed time between two promotion airings for a project should be large enough to avoid duplication of audience. If the project is already being promoted in an adjacent show, the reward is multiplied by a fraction to minimize duplication.

Generic Promotions (Gₜ): Generic promotions do not promote a specific airing of the show. They are normally used when a non-generic promotion is not available. To minimize the use of generic promotions when other promotions are available, the reward is multiplied by a fraction when other promotions are available.

The reward function may be calculated as follows:

R_{qs}=AₛₕrₜL_{q}SₜNₜDₜPₜGₜ

With the ability to calculate a reward function for each promotion relative to a program, further calculations can be performed in order to generate an entire schedule which maximizes the effectiveness of the promotional placements. The promotion scheduling problem can be formulated mathematically as follows:

$$\begin{matrix}min {\sum }_{q ∈ Q} {\sum }_{s ∈ S} {R}_{qs} {x}_{qs} + {\sum }_{p ∈ P} {Π}_{p} {u}_{p} & & \\ s . t . {\sum }_{q ∈ Q} {L}_{q} {x}_{qs} \leq {T}_{s} , & all s ∈ S & inventory constraints \\ {\sum }_{q ∈ {Q}_{p}} {\sum }_{s ∈ S} {A}_{{sD}_{p}} {x}_{qs} + {u}_{p} \geq {I}_{p} , & all p ∈ P & impression requirement \\ constraints & & \\ {x}_{qs} ∈ \{ 0 , 1 \} , & all q ∈ Q , s ∈ S & integrality\end{matrix}$$

Where:

x_{qs} equals a variable indicating the assignment of a promotion q to a show s.

Πₚ=the proportional penalty cost incurred for not meeting the desired impressions for the project p.

uₚ=the number of impressions not met for project p.

Tₛ=the amount of time available for promotions on show s.

A_{sDp}=the total audience for show s in demographic Dₚ.

Iₚ=the total number of impressions desired for the project p in the demographic Dₚ.

The desired solution to the above formulation maximizes the total reward obtained over the entire schedule. The first term in the first equation is the objective function. The second term in the objective function gives the cost associated with not meeting the impressions requirements for the projects. Πₚ is chosen to have a large positive value. This ensures that the variables for unmet impressions, uₚ, are as small as possible in the optimal solution.

The second equation determines if there is sufficient inventory available to meet all the impressions requirement constraints, the variables uₚ are zero in the optimal solution. Projects with high priorities have higher values of uₚ than those with lower priorities. The inventory constraints ensure that the inventory available on each show is not exceeded by the promotion placement. The right side gives the sum of the lengths of all the promotions that are placed on a show and the left is the total inventory available on the show.

The first term on the right side of the impressions requirement constraint gives the total number of impressions of demographic Dₚ that the project p is promoted to. The sum of this term and uₚ (the number of unmet impressions due to lack of inventory) should be greater than the impressions required for project p in its desired demographic Dₚ. Note that uₚ will be zero in the solution of the problem if there is sufficient inventory available, otherwise, it will be chosen to be as small as possible. The problem presented is an integer program and can be solved using any one of several existing math program solvers. However, the problem is NP-complete and may take an extended amount of time in order to solve. This program may be solved on a CPLEX 6.0 software on a Pentium PC with a 120 megahertz clock speed and 24 Mb of RAM.

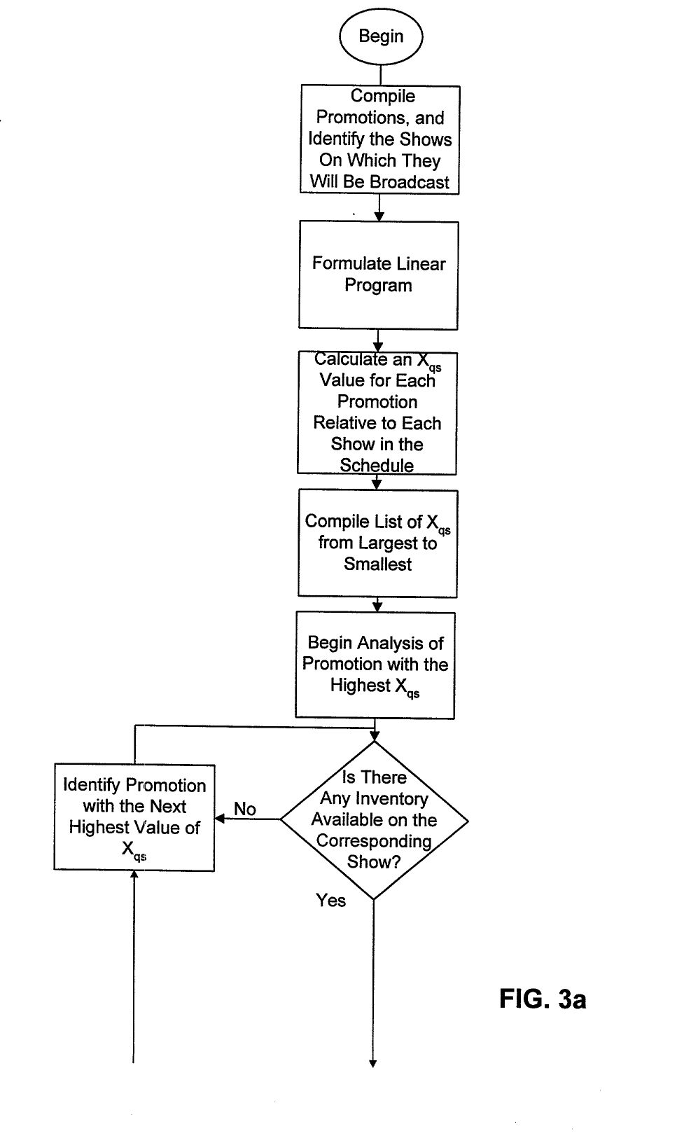

In another embodiment of the invention, the problem described above may be solved in a more time effective fashion. Referring again to the above first equation, the first step is to relax the integer constraints on fractional values, x_{q}s, as disclosed in problem 1. i.e. we allow x_{qs} to take any value between 0 and 1. The resulting problem is a linear program (LP) and can be solved very quickly using any math program solver. For example, the CPLEX 6.0 may be used to solve this program. To begin the process, a value for x_{q}s is solved for each promotion relative to the shows in the broadcast schedule. FIG. 2 is an example of a partial table created as a result of solving the x_{q}s value for each promotion. The entire table includes the x_{q}s values for all the promotions versus all the shows. As can be seen, the x_{qs} values are sorted in descending order. Once the list is sorted, each corresponding promotion is analyzed according to a number of additional criteria. First, a check is performed to determine if there is sufficient inventory on a particular show in order to broadcast a promotion. Another check is performed to determine whether the particular project, for which the promotion was created for, has met its impressions requirements. Finally, a third check is performed to determine if the airing of the promotion is too close to the airing of other promotions for the same project. This analysis is performed for all the promotions in descending order of x_{q}s value. After all the elements in the sorted list for each show are considered, there might be projects with unmet impressions and shows with available inventory. Placement of these additional promotions may be made through solution of the NP-complete problem which can now be solved in a more expeditious manner due to the reduced number of promotions and available inventory.

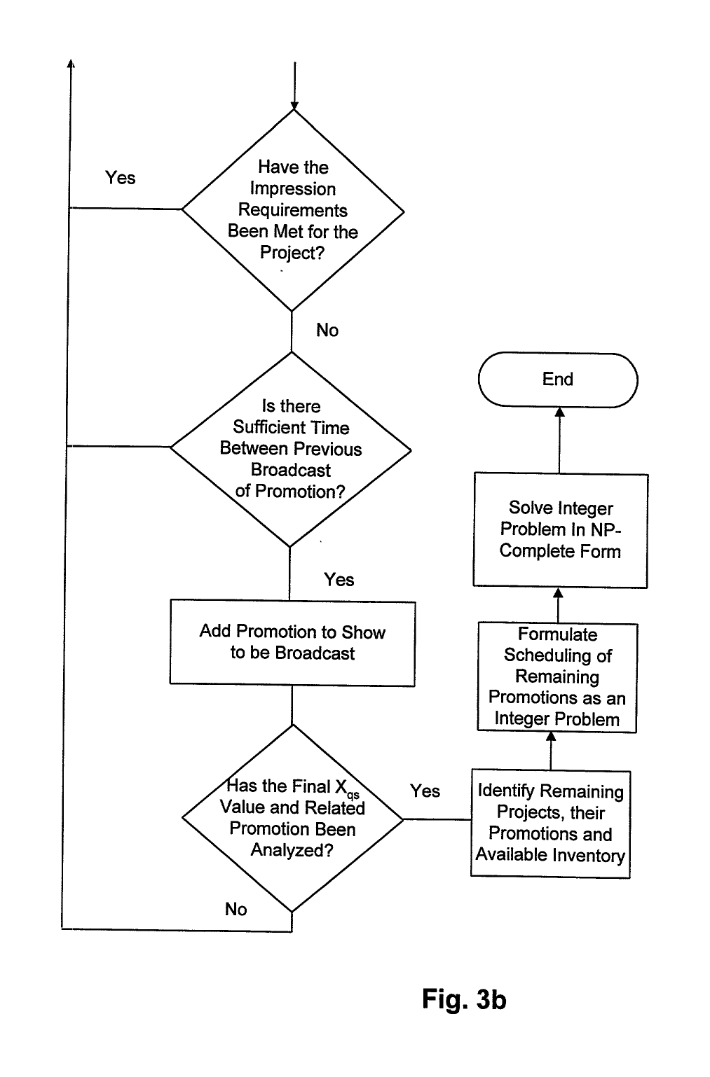

A detailed description of the process of creating the schedule is described in greater detail in FIG. 3. As mentioned above, the first step in the process is to identify all of the promotions which are to be broadcast during a particular segment of the TV schedule. For example, a list of promotions may be created only to be broadcast in the prime time schedule as disclosed in FIG. 1, or the list of promotions may be broadcast in all parts of the schedule. Once the promotions and shows are identified, a linear program is set up to solve for the x_{q}s.

As was disclosed previously in FIG. 2, the fractional values are compiled in a list from the largest to the smallest. The highest x_{qs} value is then further analyzed to take into account some additional criteria. The first of these criteria is whether there is any available promotion inventory on the identified show in which the promotion may be broadcast. For example, if the promotion is one minute in length, and the available promotion inventory is only thirty seconds, the first promotion is passed over.

The next step is to determine whether the impressions requirements have been met for the project in which the promotion was created for. If the impressions requirements have been met for the project there is no reason to further broadcast the promotions, and the next promotion in the list is then analyzed to determine whether it can be broadcast in the available inventory.

If there is available inventory and the impression requirements have not been met, a final question is asked as to whether the promotion is being broadcast too soon after its previous broadcast time. Promotions lose their effectiveness if they are broadcast in close proximity to each other because they are essentially reaching the same audience, and the goal is to reach the largest audience possible.

If any of the above steps fails, the next x_{qs} in the list is identified and the process begins again. The analysis continues until all the x_{qs} and the related promotions and shows are analyzed. Once the analysis of the list is complete, it is conceivable that there may still be inventory available or impression requirements have not been met for a particular project. The remaining problem is the same as the original, but much smaller in size. The problem may be reformulated as an integer problem and solved using a standard math program. Because the problem is much smaller in scope it can be solved in a reasonable amount of time.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method for scheduling promotions for airing in a broadcast schedule comprising the steps of:
identifying a plurality of the promotions to be shown on a schedule of programs to be broadcast;
providing quantitative factors to evaluate the airing of the promotions at various points in the broadcast schedule;
applying the factors to generate a reward function for each of the promotions relative to each of the shows in the broadcast schedule; and
using the reward functions and at least one additional factor to schedule the plurality of the promotions in the broadcast schedule to receive a maximum reward.

2. The method of claim 1 wherein the at least one additional factor include at least one of: impression requirements, inventory constraints, and recency.

3. The method of claim 1 wherein the quantitative factors includes at least one of: length of the promotion, total audience for show in a particular demographic, recency, show similarity, number in line-up, show day-part, duplication and generic promotion factors.

4. The method of claim 1 wherein the maximum reward is solved as an integer program.

5. The method of claim 1 wherein the maximum reward is a product of the reward function, proportional penalty cost for not meeting the desired impressions for the promotions and the number of impressions not met for projects which the promotions were created for.

6. The method of claim 2 wherein the inventory constraints are related to the number of shows and time left on these shows to broadcast project.

7. The method of claim 2 wherein the impression requirements are related to the total audience for a show in a particular demographic.

8. A method for scheduling promotions for airing in a broadcast schedule comprising the steps of:
identifying a plurality of the promotions to be shown on a schedule of programs to be broadcast;
providing quantitative factors to evaluate the airing of the promotions at various points in the broadcast schedule;
applying the factors to generate a reward function for each of the promotions relative to each of the shows in the broadcast schedule; and
using the reward functions, calculating a probability function for each of the promotions relative to each of the shows in the broadcast schedule, and compiling a list for each of the shows of the promotions ranked according to the probability values;
for all of the shows in the broadcast schedule, using at least one additional factor to analyze each of the promotions on the lists in order of probability to determine suitability for airing the promotion.

9. The method of claim 8 wherein the at least one additional factor include at least one of: impression requirements and inventory constraints.

10. The method of claim 8 wherein the quantitative factors includes at least one of: length of the promotion, total audience for show in a particular demographic, recency, show similarity, number in line-up, show day-part, duplication and generic promotion factors.

11. The method of claim 8 wherein the reward function is a function of at least one of: show projection, recency, length of the promotion, similarity of the show, number of the shows promoted, the show day part, duplication, and generic promotions.

12. The method of claim 9 wherein the inventory constraints are related to the number of shows and time left on these shows to broadcast projects.

13. The method of claim 9 wherein the impression requirements are related to the total audience for a show in a particular demographic.
